(19) United States
(12) Patent Application Publication
(10) Pub. No.: US 2025/0338800 A1
(43) Pub. Date: Nov. 6, 2025

(54) RIDGE BEAM

(71) Applicant: VAN DER HOEVEN HORTICULTURAL PROJECTS B.V., Den Hoorn (NL)

(72) Inventor: Sven Peter VAN HEIJNINGEN, Wateringen (NL)

(21) Appl. No.: 18/865,849

(22) PCT Filed: May 16, 2023
(86) PCT No.: PCT/EP2023/063047

§ 371 Date: Nov. 14, 2024

(30) Foreign Application Priority Data
May 17, 2022 (NL) 2031896

(51) Int. Cl. A01G 9/14; A01M 29/34; E04D 13/04

(52) U.S. Cl. CPC A01G 9/1438; A01G 9/1476; A01M 29/34; E04D 13/0404; A01G 2009/1446

(57) ABSTRACT

The invention is directed to a ridge beam for use in a roof of a building and having an upper side and a lower side, wherein the ridge beam is comprised of an elongated middle section and two elongated side sections. The elongated middle section is provided with openings along its length such to fluidly connect an interior of the building with an exterior of the building. An elongated air permeable screen is present facing the upper side of the ridge beam and having two elongated sides which are connected to the two elongated side sections.

The invention is directed to a ridge beam and screen combination for use in a roof of a building and a greenhouse comprising the ridge beam and screen combination.

US2009/0094910 describes a ridge beam to which at both sides of the ridge beam a closable window is present. In the opening of the window an insect screen is positioned in the plane of the roof. When the window opens the screen stays in place. Through the insect screen an opening is present for passage of an actuator which can move the window to an open position and back to a closed position.

A problem with this known ridge beam and screen combination is that the windows with the screen block a substantial amount of sunlight which otherwise could be used for the growing plants.

The object of this invention is to provide a ridge beam and screen combination which does not have the disadvantages of the prior art ridge beam and screen combination.

This is achieved by the following ridge beam. A ridge beam for use in a roof of a building and having an upper side and a lower side, wherein the ridge beam is comprised of an elongated middle section and two elongated side sections,
wherein the elongated middle section is provided with openings along its length such to fluidly connect an interior of the building with an exterior of the building and
wherein an elongated air permeable screen is present facing the upper side of the ridge beam and having two elongated sides which are connected to the two elongated side sections.

The ridge beam according to the invention blocks less sunlight because the openings and screen are present in the elongated ridge beam itself or just above and not as windows extending from the ridge beam in the plane of the roof.

In this application reference will be made to terms like upper, lower, above, below, horizontally and vertically. These terms are used to more clearly describe the ridge beam in its orientation wherein it would normally be positioned in a roof of a building. These terms should not be used to limit the claims to a ridge beam only in this orientation.

The elongated air permeable screen may be connected to the two elongated side sections by fixing the elongated sides of the elongated air permeable screen in an elongated slot as present in the side sections.

The elongated slot may have an entrance opening to said slot extending along the length of said slot and wherein the entrance opening faces horizontally away from the ridge beam or faces more downwardly from this horizontal facing. Preferably at one or both sides of the entrance opening a ridge is present which fixes the elongated sides of the elongated air permeable screen in the elongated slot.

The elongated air permeable screen may run in any shape from the slot as present in one elongated side section to the slot as present in the other elongated side section. Such a shape may involve corners running parallel to the ridge beam. Preferably the screen runs along a curved plane, more preferably along a section of a circle, from the slot as present in one elongated side section to the slot as present in the other elongated side section.

Preferably the sides of the elongated air permeable screen are thicker than the remaining screen to obtained a thickened side. This thickened side may be fixed in the elongated slot by means of a snap fit connection. The thickened side may be obtained by folding the elongated sides of the screen like a hem. When a metal screen is used the fold itself may keep the thickened side in place such that unlike in a hem no further connection is required. Within the folded side a string, for example a rubber string, may be present to further thicken the sides. Alternatively a string may be attached to the side by sowing.

The air permeable screen is preferably an insect screen. The screen may be made of carbon fibres, glass fibres, polyester fibres and metal wires. Suitably a metal insect screen is used. The openings in the screen do not allow insects to pass. The screen suitably has a mesh/inch of between 20×20 to 150×150. When the screen is made of metal wires the wire diameter is suitably between 0.1 and 1 mm. A preferred mesh is 60×60.

The preferred metal insect screen is suitably provided two inward folded sides of the screen as the thickened sides, optionally provided with a string, like for example a rubber string to further enhance the thickness.

The ridge beam comprises an elongated middle section and two elongated side sections. The middle section may be flat plate provided with openings along its length such to fluidly connect an interior of the building with an exterior of the building. The side sections are preferably provided with the above described elongated slots. Below these slots suitably an elongated sleeve is present for fitting glass panels when the ridge beam is used as part of a greenhouse. The middle section and side sections may be manufactured as separate parts which are connected to become the ridge beam. Preferably the middle section and side sections are manufactured as a single part. The middle section and side sections may be made from a fibre reinforced polymer and preferably a carbon fibre reinforced polymer. Preferably the separate sections or the single part is made of a metal, preferably an aluminium comprising alloy. Preferably the metal parts or single part is made by extrusion.

The openings as present in the elongated middle section are preferably closable openings. More preferably at the upper end of the ridge beam an elongate valve is present which can rotate in a tubular space along an axis parallel to the ridge beam and wherein the valve can close the closable openings and wherein the elongated air permeable screen runs from the slot as present in one elongated side section to the slot as present in the other elongated side section such that it does not intrude into the tubular space. Examples of such valves are described in US2020/0315101.

The ridge beam according to this invention is preferably used as part of a greenhouse. The invention is therefore also directed to a Greenhouse provided with a roof comprising one or more ridge beams according to this invention and rafters, wherein to the two elongated side sections transparent panels or sheets are connected.

The greenhouse may have a roof having the shape of a number of parallel oriented saddle roofs each provided with the ridge beam. Alternatively the greenhouse is of the tunnel type and wherein transparent polymer sheets are connected to the two elongated side sections.

In order to capture any rain water which enters the greenhouse via the openings in the ridge beam it is preferred to have a gutter which is positioned below the openings in the ridge beam. The gutter may be fluidly connected to metal rafters for discharge of water to the exterior of the greenhouse. Such an internal gutter may also find use in embodiments which do not necessarily have a screen according to this invention. Therefore the invention is also directed to a greenhouse having a saddle roof comprising of more than one ridge beams, wherein from each ridge beam rafters extend to a lower positioned external gutter, wherein the ridge beam is provided with openings along its length such to fluidly connect an interior of the greenhouse with an exterior of the greenhouse and wherein an internal gutter for collecting rain water is positioned below the openings in the ridge beam, which internal gutter is fluidly connected to a hollow internal space of the metal rafters and wherein the hollow internal space of the metal rafters is fluidly connected to the external gutters for discharge of the rain water to the exterior of the greenhouse. The ridge beam of such a greenhouse suitably has the features of the ridge beam of this invention. The ridge beam may thus be comprised of an elongated single metal part obtained by extrusion. The metal is an aluminium comprising alloy. The openings as present in the ridge beam are suitably closable openings. Preferably at the upper end of the ridge beam an elongate valve is present which can rotate in a tubular space along an axis parallel to the ridge beam and wherein the valve can close the closable openings. Preferably the more than one ridge beam is a ridge beam according to this invention.

The greenhouse may be further provided with means to take in air from the exterior of the greenhouse, an air conditioning mixing zone suited to mix air from the exterior of the greenhouse with air from within the greenhouse and means to distribute air from the air conditioning zone to the interior of the greenhouse via a multitude of ventilation ducts fluidly connected to the air conditioning mixing zone. The air conditioning mixing zone is suitably provided with means to cool, heat, humidify or dehumidify the air before it is distributed into the greenhouse as illustrated in for example WO2004032606, WO0076296, WO2015/012698 and WO2008002686. The ventilating ducts may be any device which provides a substantially even distribution of the air into the greenhouse. Preferably the air is discharged from these ducts in the greenhouse at a position below the cultivation. Examples of such ventilating conduits are for example described in EP1464219, WO0076296, NL1038219 and in US2010/0126062.

The invention is also directed to a process to connect an elongated air permeable screen having two elongated sides to an elongated part having an upper side and a lower side wherein the metal part comprises of two elongated side sections each side section provided with an elongated slot facing away from the elongated metal part by forcing each of the elongated sides of the elongated air permeable screen into one of the elongated slots by means of a first linear cam. In this process the first linear cam directs the elongated sides of the elongated air permeable screen into one of the elongated slots at the relative position of the first cam to the elongated slot. By moving the first linear cam along the elongated slot for a distance×a length×of the elongated air permeable screen is connected to one of the elongated slots. By simultaneously moving two first cams each along one of the elongated slots for a distance×a length×of the elongated air permeable screen is connected to both of the elongated slots.

Preferably the thickened side is obtained by a second linear cam wherein at one side of the cam an elongated air permeable screen is continuously fed to a cam passage. In the cam passage part of the side folds inwardly when passing the second cam to obtain a folded air permeable screen having two thickened sides. These thickened sides of the thus obtained folded air permeable screen is continuously forced into one of the elongated slots by means of the first linear cam as described above.

Preferably the first cam and second cam are both connected to one carriage which carriage is moveably supported by the elongated single metal part. In this way the elongated single metal part serves as a mono-rail along which the carriage can move. The movement of the carriage thus operate first cams and second cam. The carriage may be mechanically moved or manually.

The elongated air permeable screen may be fed to the first cams or to the second cam if present from a roll of the elongated air permeable screen.

The elongated part may consists of separate connected parts. In the process any length of elongated air permeable screen may be connected to the elongated part or parts. In some applications the total length of the elongated part or connected parts may range up to 400 m and sometimes even above. When large length require to be connected with the screen it may be necessary to connect smaller lengths of screen by the process of this invention.

The elongated part may be a fibre reinforced polymer, such as glass fibre or carbon fibre reinforced polymer. Preferably the part is a metal part and more preferably an aluminium comprising alloy. The metal part of preferably obtained by extrusion. The part may be a single part of composed of separately manufactured parts which are connected to one elongated part. The elongated part preferably comprises the elongated middle section and the two elongated side sections of the ridge beam according to this invention. Preferably the elongated air permeable screen is as described above.

The invention is also directed to the carriage described above. Such a carriage is suited to be moveably connected to an elongated single metal part and has a driving direction comprising
a first linear cam suited to force a thickened side of a screen into an elongated slot of the elongated metal part and forces an opposite thickened side of the screen into another elongated slot of the elongated metal part when moving the carriage in the driving direction along the elongated single metal part and
a second linear cam comprising of an inlet opening for an elongated screen, a cam passage having a design which folds the two sides of the elongated screen inwards to obtain the screen with two thickened sides when moving the carriage in the driving direction along the elongated single metal part and an outlet opening for the air permeable screen having two thickened sides facing the first cam.

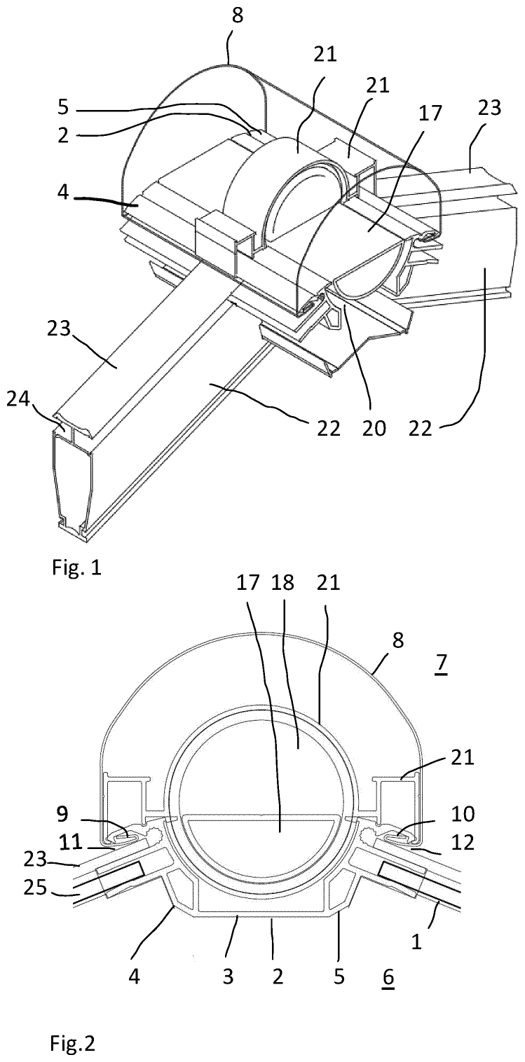

The invention will be illustrated by the following non-limiting FIGS. 1—

FIG. 1 shows a three dimensional view of a section of part of the upper end of a saddle roof (1) of a greenhouse provided with a ridge beam (2) according to this invention. FIG. 2 shows a side view in the axial direction of the section shown in FIG. 1 wherein the rafters (22) are not shown to improve clarity. The ridge beam (2) has an elongated middle section (3) and two elongated side sections (4,5). The middle section (3) is provided with one or more openings (20) along its length. Below openings (20) an internal water gutter (13) is positioned for collecting rain water which may enter the greenhouse via openings (20).

An elongated metal insect screen (8) is present facing the upper side of the ridge beam (2) and having two elongated sides (9,10). Side (9) is connected to the elongated side section (4) in an elongated slot (11) and side (10) is connected to the elongated side section (5) in an elongated slot (12). The metal insect screen runs along a curved plane from slot (11) as present in elongated side section (4) to the slot (12) as present in elongated side section (5) as shown.

The elongated middle section is provided with openings (20) along its length such to fluidly connect an interior (6) of the greenhouse building with an exterior (7) of the greenhouse.

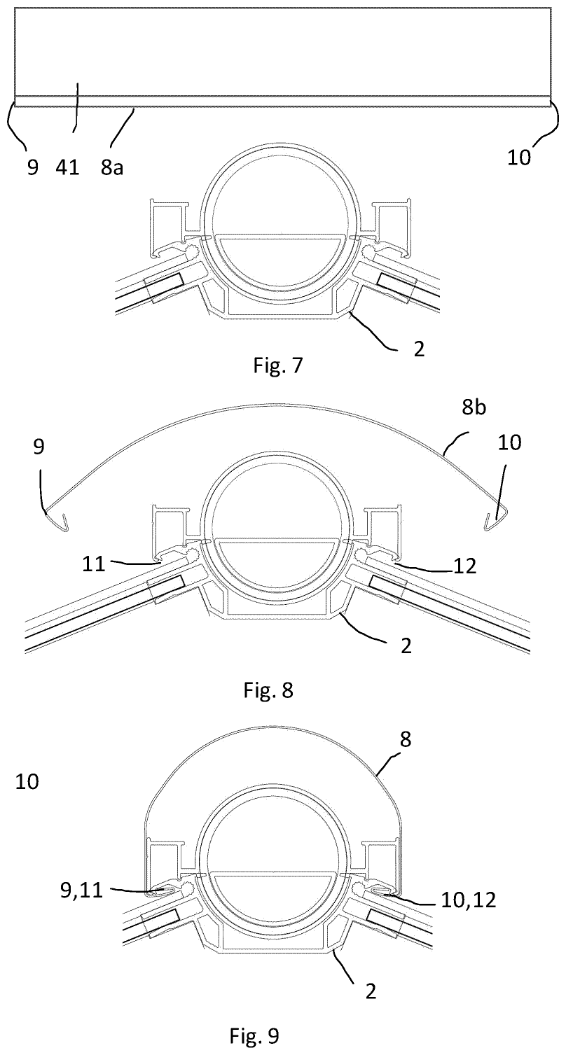

An elongated valve (17) as known from FIGS. 7a-7c of WO19125169 is present which can rotate in a tubular space (18) along an axis parallel to the ridge beam (2). The screen (8) does not intrude into the tubular space (18). In the Figure the valve (17), which has the shape of a axial section of a cylinder, is in its closed position thereby closes opening (20) and thus fluidly disconnecting interion (6) and exterior (7) of the greenhouse. The elongated valve (17) is supported by bearing housing (21). Bearing housing (21) may be present at the point where rafters (22) and ridge beam (2) are connected as shown in FIG. 1. Rafters (22) are provided with a glazing bar (23) and a slot (24) for a glass panel (25) not shown in FIG. 1 and shown in FIG. 2.

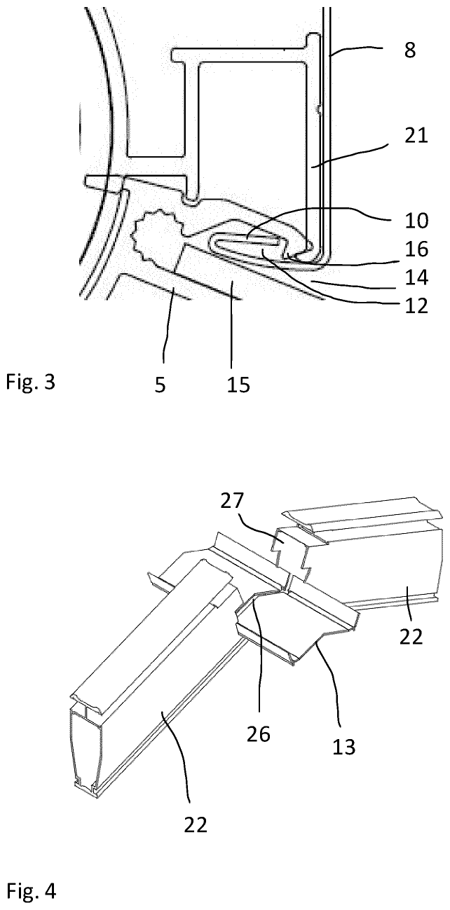

FIG. 3 shows elongated slot (12) of FIGS. 1 and 2 in more detail. The side (10) of the elongated metal insect screen (8) is an inward folded side of the screen resulting in that the side is thickened. The elongated slot (12) has an entrance opening (14) extending along the length of said slot (12) facing more downwardly and parallel to a glazing bar (15). At the upper end of the entrance opening (14) a ridge (16) is present which fixes the thickened elongated sides (10) of the screen (8) in the elongated slot (12) by means of a snap fit connection. The opposite side (9) of the elongated metal insect screen (8) is connected identically as shown in FIG. 3.

FIG. 4 shows the internal gutter (13) of FIG. 1 more clearly. The ridge beam (2) is not shown to clarify how gutter (13) is positioned and functions. Gutter (13) is provided with openings (26) through which collected rain water can enter the hollow inner space (27) of rafters (22). Via the hollow rafters (22) the water will flow downwards to be discharged into a gutter which is present at the lower ends of a saddle roof of a greenhouse.

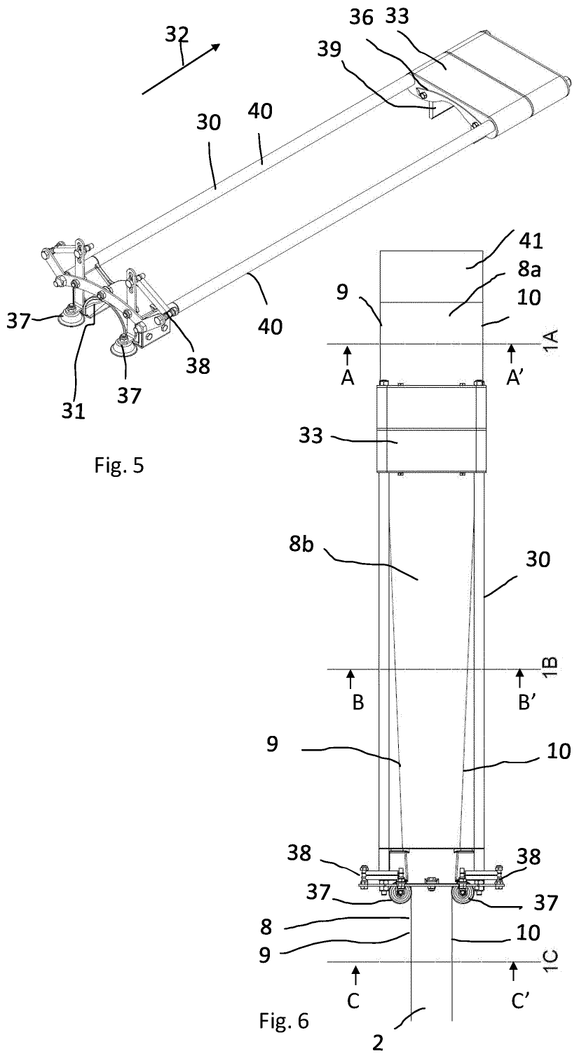

FIG. 5 shows a carriage (30) suited to be moveably connected to a ridge beam (2) of FIG. 1 with the object to add screen (8) to the ridge beam (2). FIG. 6 shows carriage (30) connected to the ridge beam (2) in the process to connect the screen (8) to the ridge beam (2). A first linear cam (31) suited to force the thickened side (9) of the screen (8) into the elongated slot (11) of the elongated metal part and forces an opposite thickened side (10) of the screen (8) into elongated slot (12) when moving the carriage in a driving direction (32) along the ridge beam (2). A second linear cam (33) having an inlet opening (34) for the elongated screen (8a), a cam passage (35) having a design which folds the two sides (9,10) of the elongated screen (8) inwards to obtain the screen (8b) with two thickened sides of FIG. 1-3 when moving the carriage (30) in the driving direction (32) along the elongated ridge beam (2). An outlet opening (36) for the screen (8b) having two thickened sides facing the first linear cam (31). At the first linear can (31) two guiding wheels (37) are shown which are forced by springs (38) towards the ridge beam (2) when in use. The second linear cam (33) is provided with two sledges (39) which rest on the neighbouring glass panels (25). Because no screen is attached at that location when connecting the screen such a support is possible. The first linear cam (31) and the second linear cam (33) are spaced apart by means of two beams (40) which may be adjustable in length such to optimise an easy connecting process. The first linear cam (31) is further provided with a tubular section part (41) which forced the screen (8b) to the desired curved plane.

In FIG. 6 the shows carriage (30) connected to the ridge beam (2) in the process to connect the screen (8) to the ridge beam (2). A substantially flat screen (8a) which may be fed from a roll (41) of screen (8a) having two elongated sides (9,10) is fed to the inlet opening (34) of second cam (33). In second linear cam (33) part of the sides (9,10) are folded inwardly when passing the second cam by movement of the carriage (30) in direction (32) to obtain a folded air permeable screen (8b) having two thickened sides (9,10). The thickened sides (9,10) are continuously forced into one of the elongated slots (11,12) by means of the first linear cam (31) when the screen (8b) passes the first cam (31) by movement of the carriage (30) in direction (32). In the process the screen and ridge beam do not move in an longitudinal direction relative to each other. The connection is achieved by the longitudinal movement of the carriage (30) in direction (32).

FIG. 7 is cross-sectional view AA′ of FIG. 6. No screen is attached to ridge beam (2). The substantially flat screen (8a) is fed from a roll (41) and is present at a distance above ridge beam (2).

FIG. 8 is cross-sectional view BB′ of FIG. 6. The carriage (30) is not shown. Shown is that the sides (9,10) are folded as a result of passing second linear cam (33).

FIG. 9 is a cross-sectional view CC′ of FIG. 6. The screen (8) is connected to the ridge beam (2) wherein the thickened sides (9,10) are positioned in the elongated slots (11,12).

1. A ridge beam for use in a roof of a building and having an upper side and a lower side, wherein the ridge beam is comprised of an elongated middle section and two elongated side sections,
wherein the elongated middle section is provided with openings along its length such to fluidly connect an interior of the building with an exterior of the building, and
wherein an elongated air permeable screen is present facing the upper side of the ridge beam and having two elongated sides which are connected to the two elongated side sections.

2. A ridge beam according to claim 1, wherein the elongated air permeable screen is connected to the two elongated side sections by fixing the elongated sides of the elongated air permeable screen in an elongated slot as present in the side sections.

3. A ridge beam according to claim 2, wherein the sides of the elongated air permeable screen are thicker than the remaining screen to define a thickened side and wherein the thickened side is fixed in the elongated slot by means of a snap fit connection.

4. A ridge beam according to claim 1, wherein the air permeable screen is a metal insect screen.

5. A ridge beam according to claim 4, wherein the metal insect screen has a mesh/inch of between 20×20 to 150×150 having a wire diameter of between 0.1 and 1 mm.

6. A ridge beam according to claim 3, wherein the air permeable screen is a metal insect screen providing two inward folded sides of the screen as the thickened sides.

7. A ridge beam according to claim 2, wherein the elongated slot has an entrance opening to said slot extending along the length of said slot and wherein the entrance opening faces horizontally away from the ridge beam or faces more downwardly from this horizontal facing.

8. A ridge beam according to claim 7, wherein at one or both sides of the entrance opening a ridge is present which fixes the elongated sides of the elongated air permeable screen in the elongated slot.

9. A ridge beam according to claim 7, wherein the elongated air permeable screen runs along a curved plane from the slot as present in one elongated side section to the slot as present in the other elongated side section.

10. A ridge beam according to claim 1, wherein the ridge beam is comprised of an elongated single metal part obtained by extrusion.

11. A ridge beam according to claim 10, wherein the metal is an aluminum-comprising alloy.

12. A ridge beam according to claim 1, wherein the openings as present in the elongated middle section are closable openings.

13. A ridge beam according to claim 12, wherein at the upper end of the ridge beam an elongate valve is present which can rotate in a tubular space along an axis parallel to the ridge beam and wherein the valve can close the closable openings and wherein the elongated air permeable screen runs from the slot as present in one elongated side section to the slot as present in the other elongated side section such that it does not intrude into the tubular space.

14. A greenhouse provided with a roof comprising one or more ridge beams according to claim 1 and rafters, wherein to the two elongated side sections transparent panels or sheets are connected.

15. A greenhouse according to claim 14, wherein a gutter is positioned below the ridge beam for collecting rain water, wherein the rafters comprise metal rafters, and wherein the gutter is fluidly connected to at least one of the metal rafters for discharge of the rain water to the exterior of the greenhouse.

16. A greenhouse according to claim 14, wherein the roof has the shape of a number of parallel oriented saddle roofs each provided with the ridge beam.

17. A greenhouse according to claim 14, wherein the greenhouse is of a tunnel type and wherein transparent polymer sheets are connected to the two elongated side sections.

18. A greenhouse house according claim 14, wherein the greenhouse is further provided with means to take in air from the exterior of the greenhouse, an air conditioning mixing zone suited to mix air from the exterior of the greenhouse with air from within the greenhouse and means to distribute air from the air conditioning zone to the interior of the greenhouse via a multitude of ventilation ducts fluidly connected to the air conditioning mixing zone.

19. A process to connect an elongated air permeable screen having two elongated sides to an elongated single metal part having an upper side and a lower side wherein the metal part comprises of an elongated middle section and two elongated side sections each side section provided with an elongated slot facing away from the elongated single metal part by forcing each of the elongated sides of the elongated air permeable screen into one of the elongated slots by means of a first linear cam.

20. A process according to claim 16, wherein the sides of the two elongated sides of the elongated air permeable screen are thicker than the remaining screen to obtained a thickened side and wherein the thickened side is fixed in the elongated slot by means of a snap fit connection.

21-38. (canceled)
